(19) United States
(12) Patent Application Publication
(10) Pub. No.: US 2011/0298594 A1
(43) Pub. Date: Dec. 8, 2011

(54) REMOTE CONTROL FOR AN E-READER

(76) Inventors: Patrick Mish, Odenton, MD (US); Jim Ward, Ashburn, VA (US); Adam Ashley, Odenton, MD (US)

(21) Appl. No.: 13/100,100

(22) Filed: May 3, 2011

Related U.S. Application Data
(63) Continuation of application No. 12/906,891, filed on Oct. 18, 2010, now abandoned.
(60) Provisional application No. 61/252,671, filed on Oct. 17, 2009.

(51) Int. Cl. G08C 19/16

(52) U.S. Cl. 340/12.22

(57) ABSTRACT

An apparatus for remotely controlling an eReader device including a transceiver. The transceiver can receive an input data from a user, convert the input data to an output data and send the output data to the eReader. Further, the output data can include an eReader command.

### CROSS-REFERENCE TO RELATED APPLICATIONS

The present invention claims the benefit of U.S. Provisional Application No. 61/252,671, filed Oct. 17, 2009, and entitled “REMOTE CONTROL FOR AN E-READER”, the entire contents of which are incorporated herein by reference.

### FIELD OF THE INVENTION

The present invention relates to a remote control for an eReader, and more specifically, to a remote control for an eReader that controls one or more eReader key commands.

### BACKGROUND OF THE INVENTION

Recently, eReaders such as electronic books have become increasingly popular. Such eReaders include a display for displaying the contents of an electronic book.

A user may control the eReader using key commands including, for example, directional key commands (e.g., up, down, left, right), enter/ok, next page or previous page, or menu structure key commands (e.g., menu, home, back), etc.

To read the eReader, the user may rest the eReader on a surface, manually hold the eReader in front of the user, or place the eReader on a stand or support to position the eReader for optimal visibility for the user. The user must grasp, pick up, or physically touch the eReader to operate the key commands, for example, to change pages, which may interrupt or delay the reading process by the user. Therefore, a need exists for remotely controlling the eReader while also maintaining the functionality of the eReader device.

### SUMMARY OF THE INVENTION

These problems and others are addressed by the present invention, a first exemplary embodiment of which includes an apparatus operable for remotely controlling an eReader device, the apparatus including a transceiver. The transceiver may receive an input data from a user, convert the input data to an output data and send the output data to the eReader. Further, the output data may include at least one eReader command.

Another embodiment may also include a remote control. The remote control may receive the input data from the user and may send the input data to the transceiver. Further, the remote control may include a universal remote control.

Yet in another embodiment, the input data may include a command from the remote control device. Further, converting the input data to an output data command may include converting the output data command to a command in a programming language of the eReader.

Another embodiment may also include at least one of the following eReader command types: a next page eReader command type; a previous page eReader command type; a menu eReader command type; a home eReader command type; a back eReader command type; a QWERTY eReader command type; and a directional eReader command type.

Further, the directional eReader command type may also include any of the following eReader command types: an up command type; a down command type; a left command type and a right command type.

Another embodiment may include a method of remotely controlling an eReader device. The method may include the steps of receiving an input data from a user, converting the input data to an output data, and sending the output data to the eReader. Further, the output data may include at least one eReader command.

In yet another embodiment, the input data may include a command received from a remote control device. Further, converting the input data to an output data command may include converting the output data command to a command in a programming language of the eReader.

Another embodiment also may include any of the following eReader command types: a next page eReader command type; a previous page eReader command type; a menu eReader command type; a home eReader command type; a back eReader command type; a QWERTY eReader command type; and a directional eReader command type.

Further, the directional eReader command type may also include any of the following eReader command types: an up command type; a down command type; a left command type and a right command type.

Other features and advantages of the present invention will become apparent to those of ordinary skill in the art upon review of the following detailed description and drawings.

### BRIEF DESCRIPTION OF THE DRAWINGS

These and other aspects and features of embodiments of the present invention will be better understood after a reading of the following detailed description, together with the attached drawings, wherein:

FIG. 1 illustrates a front plan view of an exemplary eReader 100 according to an embodiment of the present invention.

FIG. 2 illustrates a front plan view of an exemplary remote control 300 and terminal 200 for an eReader 100 according to an embodiment of the present invention;

FIG. 3A illustrates a front plan view of an exemplary terminal 200 for an eReader according to an embodiment of the present invention;

FIG. 3B illustrates a side plan view of an exemplary terminal 200 for an eReader 100 according to an embodiment of the present invention;

FIG. 4 illustrates a block diagram of an exemplary terminal 200 consistent with an embodiment of the invention;

FIG. 5A illustrates a front plan view of an exemplary remote control 300 for an eReader 100 according to an embodiment of the present invention;

FIG. 5B illustrates a side plan view of an exemplary remote control 300 for an eReader 100 according to an embodiment of the present invention;

FIG. 6 illustrates a block diagram of an exemplary remote control 300 according to another exemplary embodiment of the invention; and

FIG. 7 illustrates a block diagram of an exemplary remote control 300 and terminal 200 controlling eReader 100 according to another exemplary embodiment of the invention.

### DETAILED DESCRIPTION OF THE EXEMPLARY EMBODIMENTS OF THE PRESENT INVENTION

The present invention now is described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Additionally, well-known elements of the invention will not be described in detail or will be omitted so as not to obscure the relevant details of the invention.

The word “exemplary” is used herein to mean “serving as an example, instance, or illustration.” Any embodiment described herein as “exemplary” is not necessarily to be construed as preferred or advantageous over other embodiments. Likewise, the term “embodiments of the invention” does not require that all embodiments of the invention include the discussed feature, advantage or mode of operation.

Further, many embodiments are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects of the invention may be embodied in a number of different forms, all of which have been contemplated to be within the scope of the claimed subject matter. In addition, for each of the embodiments described herein, the corresponding form of any such embodiments may be described herein as, for example, “logic configured to” perform the described action.

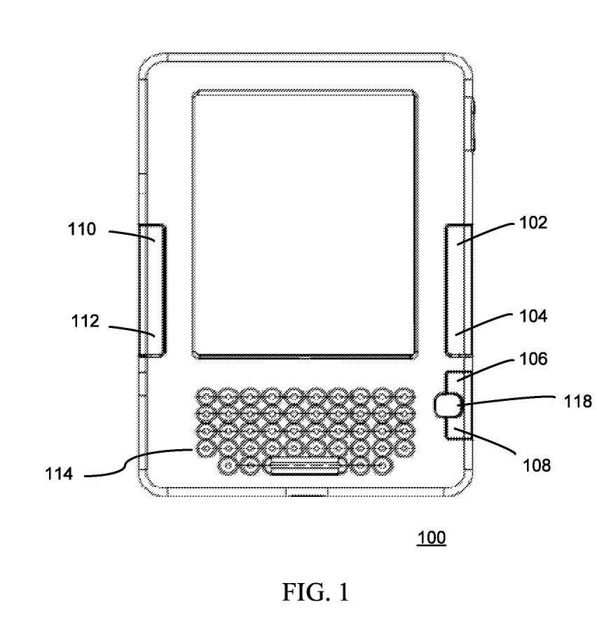

Referring now to the drawings, FIGS. 1-7 illustrate exemplary embodiments of a remote control 300 and terminal 200 for an eReader 100.

Referring to FIG. 1, an exemplary embodiment of an eReader 100 is shown. For example, the eReader 100 can include input function buttons (e.g., Home button 102, Next Page button 104, Menu button 106, Back button 108, the Previous Page button 110, Next Page button 112 and/or standard QWERTY keyboard/keypad 114) which can be utilized to input data to the eReader 100. The eReader 100 also can include a control stick 118 which can be utilized to navigate the controls of the eReader 100. In this manner, the user depresses one of the function buttons (e.g., Home button 102, Next Page button 104, Menu button 106, Back button 108, the Previous Page button 110, Next Page button 112 and/or standard QWERTY keyboard/keypad 114) and/or navigates the control stick 118 from the exterior of the eReader 100 in order to actuate a corresponding input control of the eReader 100.

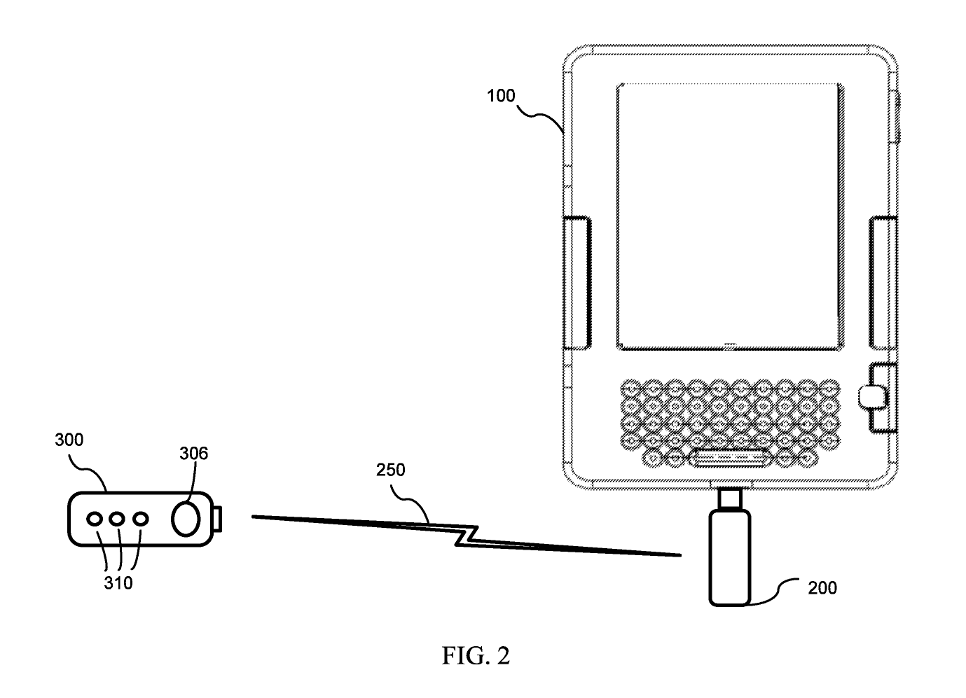

FIG. 2 illustrates an exemplary embodiment of a remote control 300/terminal 200 that may allow a user to remotely control eReader 100 via the use of one or more remote eReader key commands.

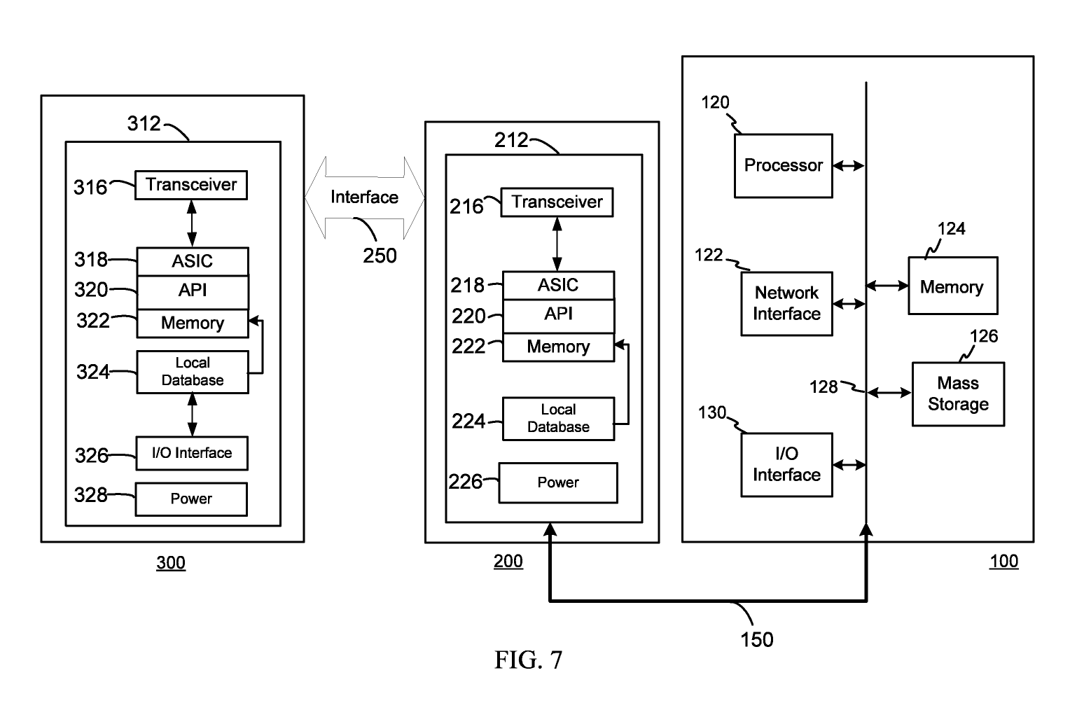

The remote control 300 can include one or more user inputs 310, for example control buttons, triggers, joysticks, toggles, etc., that correspond to one or more eReader key commands (e.g., Home button 102, Next Page button 104, Menu button 106, Back button 108, the Previous Page button 110, Next Page button 112, standard QWERTY keyboard/keypad 114) and/or a navigation guide 306 (e.g., control stick 118). The user can depress the user inputs 310 and/or the navigation guide 306 via use of the remote control 300. The remote control 300 can interact with a terminal 200 via an interface 250. The interface 250 can be an air interface and/or a wired interface. The terminal 200 can be attached to the eReader 100 or may be integrated within the eReader 100 (not shown). For example, in an exemplary embodiment, terminal 200 can be attached to the eReader 100 via a standard Universal Serial Bus (USB) connection (shown in FIG. 7 as connection 150). When the user depresses the user inputs 310 and/or a navigation guide 306 on the remote control 300, the remote control 300 will send a corresponding first command(s) to the terminal 200 via interface 250. Terminal 200 will receive the first command(s), convert the first command(s) to a second corresponding command(s), and then send a second corresponding command(s) to the eReader 100. The eReader 100 will receive the second command(s) from the terminal 200 and allow the remote control 300 to remotely control the eReader 100. Further, in one embodiment the first and second commands may be the same as one another such that terminal 200 may act as merely a repeating device. Alternatively, the first and second commands may be different from one another such that terminal 200 can provide additional processing.

The arrangement of the user inputs 310 and/or navigation guide 306 on the remote control 300 can correspond to an arrangement of user inputs on the eReader 100 itself (as described above in FIG. 1), or can have an arrangement that is unique to the remote control 300. The user inputs 310 and/or navigation guide 306 can be arranged ergonomically to allow for extended use by a user and also to minimize or eliminate fatigue. The ergonomic design of the user inputs 310 and/or navigation guide 306 can be configured for right-hand use, left-hand use, or universal use. The user inputs 310 and/or navigation guide 306 can be operated by one or more of a user's thumb or fingers.

The remote control 300 shown in FIG. 2 is for illustrative purposes only and the present invention is not limited to the illustrated features. In other embodiments, the remote control 300 can include other arrangements or configurations, such as a flat or elongated remote control having user inputs 310 and/or navigation guide 306 arranged on an upper surface or face (e.g., similar to a remote control for a radio, television, or the like), a one-handed or two-handed operation remote control configured or arranged to be operated using one hand or two hands (e.g., similar to remote controls commonly used in some types of video gaming systems), a roller wheel, dial, or optical remote control (e.g., similar to a computer mouse), a remote control having a touch-screen user interface, or similar devices.

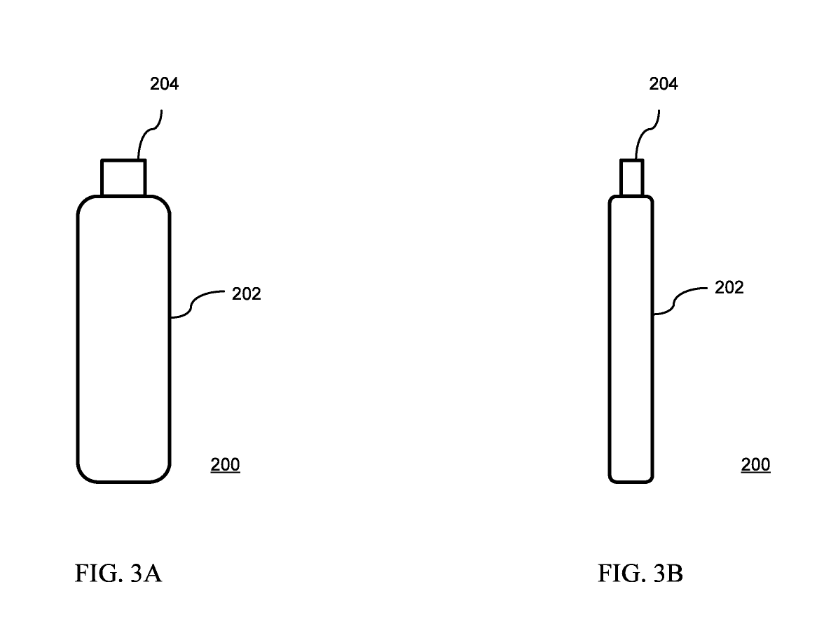

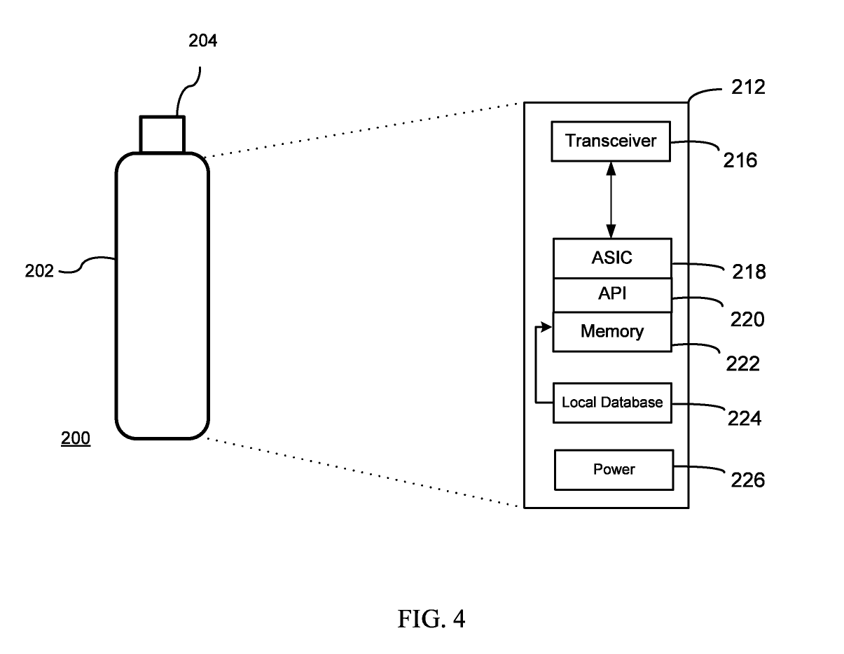

Referring to FIGS. 3A and 3B, an exemplary embodiment is illustrated of a terminal 200 that can communicate with the remote control 300. The terminal 200 can include a base portion 202 and a plug portion 204. In this exemplary embodiment, the terminal 200 can be coupled, for example, to a USB port of the eReader 100 via the plug portion 204. One of ordinary skill in the art will recognize that the terminal 200 can be coupled to the eReader 100 using other conventional means, such as a dedicated port or connection specific to the terminal 200. In an exemplary embodiment, a USB Dongle can be utilized to directly couple the USB port of the eReader 100 to the terminal 200. Further, terminal 200 may be permanently or temporarily connected to eReader 100. Base portion 202 can include a transmitting/receiving LED and/or transmitting/receiving antenna(s). Alternatively, the transmitting/receiving LED and/or transmitting/receiving antenna(s) can be contained within a transceiver 216 (shown in FIG. 4).

The communication interface 250 between the terminal 200 and the remote control 300 can include wireless and/or wired communication links. Additionally, communication between the terminal 200 and the remote control 300 can occur across any frequency bands including Radio Frequency (RF), Microwave and Infra-Red (IR) bands. For example, utilizing a wired communication link, the remote control 300 may be physically connected to the terminal 200 via the use of a coaxial cable, fiber optic cable, twisted pair, digital subscriber line (DSL) or any other equivalent. For example, utilizing a wireless communication link, the remote control 300 may be connected to the terminal 200 via the use of infra-red, radio, microwave, and or any other equivalent.

The wireless communication link between the terminal 200 and the remote control 300 can be based on different technologies, such as code division multiple access (CDMA), WCDMA, time division multiple access (TDMA), frequency division multiple access (FDMA), Orthogonal Frequency Division Multiplexing (OFDM), Bluetooth, or other protocols that may be used in a wireless communications network or a data communications network. For example, in an exemplary embodiment, the commands from the remote control 300 can be transmitted over the interface 250 to the terminal 200, using for example a wireless signal such as Bluetooth, Infrared (IR), or the like. Accordingly, the illustrations provided herein are not intended to limit the embodiments of the invention and are merely to aid in the description of aspects of embodiments of the invention.

Referring to FIG. 4, the terminal 200 can have a platform 212 that can receive and execute software applications, data and/or commands transmitted from the remote control 300. The platform 212 can include a transceiver 216 operably coupled to an application specific integrated circuit (“ASIC” 218), or other processor, microprocessor, logic circuit, or other data processing device. The ASIC 218 or other processor can execute the application programming interface (“API”) 220 layer that interfaces with any resident programs in the memory 222 of the device. Further, in one exemplary embodiment, the commands received by the transceiver 216 can be converted to the programming language of the eReader 100 and can then be sent to the microprocessor within the eReader 100 to be executed. In other embodiments, the microprocessor within the eReader 100 can receive the commands directly and/or convert the commands.

The memory 222 can be comprised of read-only or random-access memory (RAM and ROM), EEPROM, flash cards, or any memory common to computer platforms. The platform 212 also can include a local database 224 that can hold applications not actively used in memory 222. The local database 224 is typically a flash memory cell, but can be any secondary storage device as is known in the art, such as magnetic media, EEPROM, optical media, tape, soft or hard disk, or the like. The internal platform 212 components also can be operably coupled to external buttons of the eReader 100 such as input function buttons (e.g., Home button 102, Next Page button 104, Menu button 106, Back button 108, the Previous Page button 110, Next Page button 112 and/or standard QWERTY keyboard/keypad 114) and/or control stick 118 among other components, as is known in the art.

An exemplary embodiment can provide USB On-The-Go functionality within the USB chipset of the eReader. In this manner, the exemplary embodiments can provide for proper communication between the platform 212 and a microprocessor in the eReader, along with the ability to power the terminal 200 via a power portion 226. In addition to the USB On-The-Go functionality, the firmware in the microprocessor can be configured to enable the USB Host functionality for communication, along with the ability to power peripheral devices, such as the terminal 200. Furthermore, the microprocessor firmware can include API commands allowing for the execution of the user inputs 310 and/or navigation guide 306 of the remote control 300.

Accordingly, an embodiment of the invention can include a terminal 200 including the ability to perform the functions described herein. As will be appreciated by those skilled in the art, the various logic elements can be embodied in discrete elements, software modules executed on a processor or any combination of software and hardware to achieve the functionality disclosed herein. For example, ASIC 218, memory 222, API 220 and local database 224 may all be used cooperatively to load, store and execute the various functions disclosed herein and thus the logic to perform these functions may be distributed over various elements. Alternatively, the functionality could be incorporated into one discrete component. Therefore, the features of the terminal 200 in FIG. 4 are to be considered merely illustrative and the invention is not limited to the illustrated features or arrangement.

Further, the platform 212 also can include a power portion 226 that can be utilized by the terminal 200 in order to power the device. For example, in a wired embodiment, the terminal 200 can be powered via the USB chipset of the eReader, or by any batteries located within power portion 226 such as rechargeable or disposable batteries. For example, in a wireless embodiment, the terminal 200 can be powered via the USB chipset of the eReader 100. Further, the terminal 200 can include, for example, a light emitting diode (LED) that illuminates to indicate that the terminal 200 is being powered by the eReader 100 and/or is ready for use. The LED color can include various colors, including for example red, green, blue, etc.

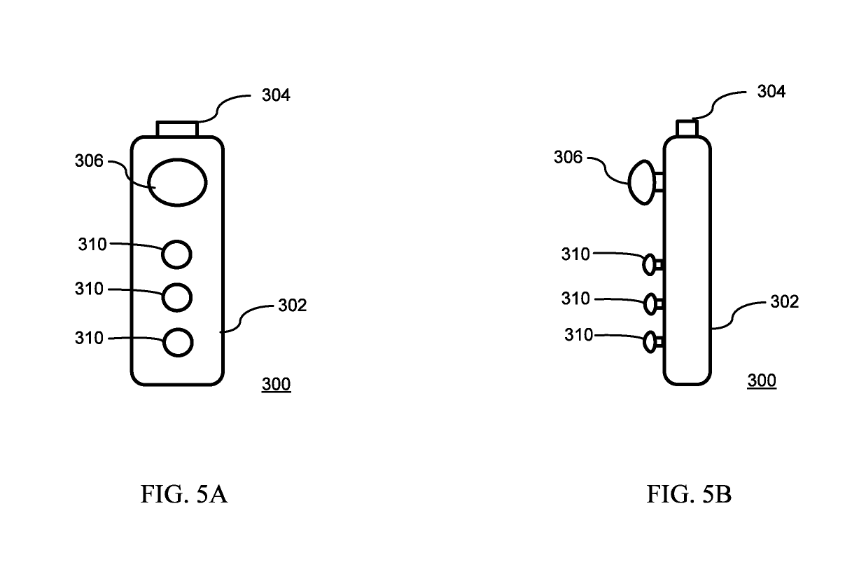

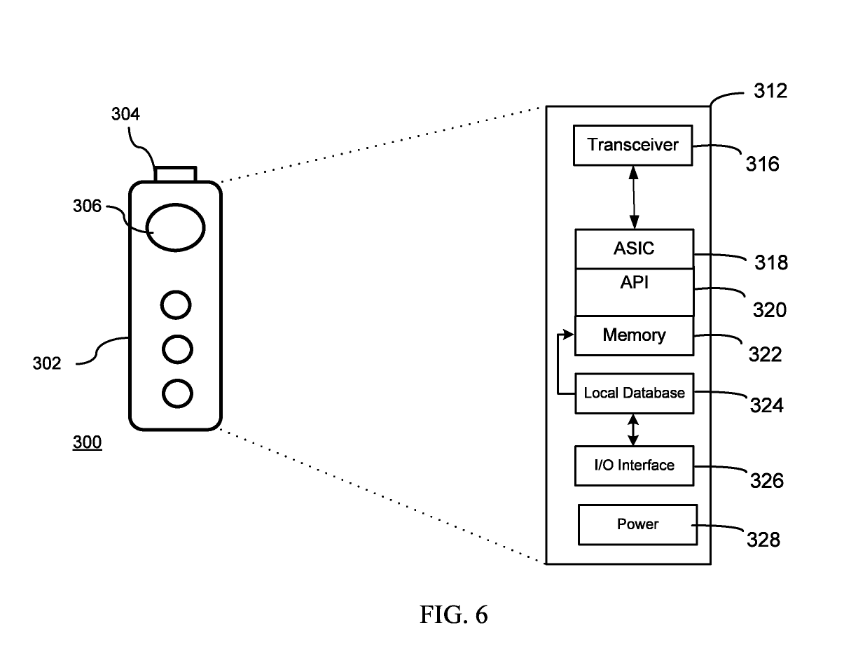

Referring to FIGS. 5A and 5B, an exemplary embodiment is illustrated of a remote control 300 that can communicate with the terminal 200 and eReader 100. The remote control 300 can include a base portion 302, a plug portion 304, navigation guide 306 and user inputs 310. Plug portion 304 can include a transmitting/receiving LED and/or transmitting/receiving antenna(s). Alternatively, the transmitting/receiving LED and/or transmitting/receiving antenna(s) can be contained within a transceiver 316 (shown in FIG. 6).

The communication interface 250 between the terminal 200 and the remote control 300 can include wireless and/or wired communication links. Additionally, communication between the terminal 200 and the remote control 300 can occur across any frequency bands including Radio Frequency (RF), Microwave and Infra-Red (IR) bands. For example, utilizing a wired communication link, the remote control 300 may be physically connected to the terminal 200 via the use of a coaxial cable, fiber optic cable, twisted pair, digital subscriber line (DSL) or any other equivalent. For example, utilizing a wireless communication link, the remote control 300 may be connected to the terminal 200 via the use of infra-red, radio, microwave, and or any other equivalent.

The wireless communication link between the remote control 300 and terminal 200 can be based on different technologies, such as code division multiple access (CDMA), WCDMA, time division multiple access (TDMA), frequency division multiple access (FDMA), Orthogonal Frequency Division Multiplexing (OFDM), Bluetooth, or other protocols that may be used in a wireless communications network or a data communications network. For example, in an exemplary embodiment, the commands from the remote control 300 can be transmitted over the interface 250 to the terminal 200, using for example a wireless signal such as Bluetooth, Infrared (IR), or the like. Accordingly, the illustrations provided herein are not intended to limit the embodiments of the invention and are merely to aid in the description of aspects of embodiments of the invention.

Referring to FIG. 6, the remote control 300 can have a platform 312 that can receive and execute software applications, data and/or commands received from the navigation guide 306 and user inputs 310 via Input/Output (I/O) interface 326. The platform 312 can include a transceiver 316 operably coupled to an application specific integrated circuit (“ASIC” 318), or other processor, microprocessor, logic circuit, or other data processing device. The ASIC 318 or other processor can execute the application programming interface (“API”) 320 layer that interfaces with any resident programs in the memory 322 of the device.

The memory 322 can be comprised of read-only or random-access memory (RAM and ROM), EEPROM, flash cards, or any memory common to computer platforms. The platform 312 also can include a local database 324 that can hold applications not actively used in memory 322. The local database 324 is typically a flash memory cell, but can be any secondary storage device as known in the art, such as magnetic media, EEPROM, optical media, tape, soft or hard disk, or the like.

Accordingly, an embodiment of the invention can include a remote control 300 including the ability to perform the functions described herein. As will be appreciated by those skilled in the art, the various logic elements can be embodied in discrete elements, software modules executed on a processor or any combination of software and hardware to achieve the functionality disclosed herein. For example, ASIC 318, memory 322, API 320 and local database 324 may all be used cooperatively to load, store and execute the various functions disclosed herein and thus the logic to perform these functions may be distributed over various elements. Alternatively, the functionality could be incorporated into one discrete component. Therefore, the features of the remote control 300 in FIG. 6 are to be considered merely illustrative and the invention is not limited to the illustrated features or arrangement.

Further, the platform 312 also can include a power portion 328 that can be utilized by the remote control 300 in order to power the device. For example, in a wired embodiment, the remote control 300 can be powered via the USB chipset of the eReader, or by any batteries located within power portion 328 such as rechargeable or disposable batteries. For example, in a wireless embodiment, the remote control 300 can be powered by an integral rechargeable battery, removable/replaceable disposable batteries, or removable/replaceable rechargeable batteries.

FIG. 7 illustrates a block diagram of the exemplary embodiment shown in FIG. 2 (e.g., an exemplary embodiment of the remote control 300/terminal 200 that may allow a user to remotely control eReader 100 via the use of one or more remote eReader key commands.)

The exemplary embodiment of remote control 300 (described in FIG. 6) and the exemplary embodiment of terminal 200 (described in FIG. 4) can be connected via interface 250. For example, when the user depresses the user inputs 310 and/or navigation guide 306 on the remote control 300, the remote control 300 can send a corresponding first command(s) to the terminal 200 via interface 250. Terminal 200 can receive the first command(s), convert the first command(s) to a second corresponding command(s), and then send a second corresponding command(s) to the eReader 100. The eReader 100 can receive the second command(s) from the terminal 200 and allow the remote control 300 to remotely control the eReader 100 via connection 150. Further, terminal 200 may be permanently or temporarily connected to eReader 100. Additionally, terminal 200 may be integrated within eReader 100 (not shown).

The eReader 100 may include a processor 120, a system bus 128, a mass storage unit 126, an I/O interface 130, a memory unit 124, and a network interface 122. The processor 120 may interface with memory 124 and the mass storage unit 126 via the system bus 128. The memory 124 and/or the mass storage unit 126 may contain executable instructions and data for implementing various operations for performing the remote control of the eReader device methods described herein. The network interface 122 may interface with the processor 120 over the system bus 128, and can provide an interface for communication with any available external networks. The I/O interface 130 may be provided to permit a user to interface to the external buttons of the eReader 100 such as input function buttons (e.g., Home button 102, Next Page button 104, Menu button 106, Back button 108, the Previous Page button 110, Next Page button 112 and/or standard QWERTY keyboard/keypad 114) and/or control stick 118. For example, the processor 120 may be an x86 based CPU, and utilize any operating system which may include varieties of the Windows, Unix and/or Linux operating systems. The eReader 100 may also use high-level analysis software packages and/or custom software written in any programming and/or scripting languages.

The present invention has been described herein in terms of several preferred embodiments. However, modifications and additions to these embodiments will become apparent to those of ordinary skill in the art upon a reading of the foregoing description. It is intended that all such modifications and additions comprise a part of the present invention to the extent that they fall within the scope of the several claims appended hereto.

Like numbers refer to like elements throughout. In the figures, the thickness of certain lines, layers, components, elements or features may be exaggerated for clarity.

The terminology used herein is for the purpose of describing particular embodiments only and is not intended to be limiting of the invention. Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

It will be understood that when an element is referred to as being “on”, “attached” to, “connected” to, “coupled” with, “contacting”, etc., another element, it can be directly on, attached to, connected to, coupled with or contacting the other element or intervening elements may also be present. In contrast, when an element is referred to as being, for example, “directly on”, “directly attached” to, “directly connected” to, “directly coupled” with or “directly contacting” another element, there are no intervening elements present. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper”, “lateral”, “left”, “right” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is inverted, elements described as “under” or “beneath” other elements or features would then be oriented “over” the other elements or features. The device may be otherwise oriented (rotated 90 degrees or at other orientations) and the descriptors of relative spatial relationships used herein interpreted accordingly.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The methods, sequences and/or algorithms described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a terminal. In the alternative, the processor and the storage medium may reside as discrete components in a terminal.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

While the foregoing disclosure shows illustrative embodiments of the invention, it should be noted that various changes and modifications could be made herein without departing from the scope of the invention as defined by the appended claims. The functions, steps and/or actions of the method claims in accordance with the embodiments of the invention described herein need not be performed in any particular order. Furthermore, although elements of the invention may be described or claimed in the singular, the plural is contemplated unless limitation to the singular is explicitly stated.

What is claimed is:

1. A method of remotely controlling an eReader device, the method comprising:
receiving an input data from a user;
converting the input data to an output data; and
sending the output data to the eReader, wherein the output data includes at least one eReader command.

2. The method of claim 1, wherein the input data includes a command from a remote control device.

3. The method of claim 1, wherein the converting the input data to the output data includes converting the output data command to a in a programming language of the eReader.

4. The method of claim 1, wherein the at least one eReader command includes a next page command type.

5. The method of claim 1, wherein the at least one eReader command includes a previous page command type.

6. The method of claim 1, wherein the at least one eReader command includes a menu command type.

7. The method of claim 1, wherein the at least one eReader command includes a home command type.

8. The method of claim 1, wherein the at least one eReader command includes a back command type.

9. The method of claim 1, wherein the at least one eReader command includes a QWERTY command type.

10. The method of claim 1, wherein the at least one eReader command includes a directional command type.

11. The method of claim 10, wherein the directional command type includes at least an up command type.

12. The method of claim 10, wherein the directional command type includes at least a down command type.

13. The method of claim 10, wherein the directional command type includes at least a left command type.

14. The method of claim 10, wherein the directional command type includes at least a right command type.

15. An apparatus operable for remotely controlling an eReader device, the apparatus comprising:
a transceiver, wherein the transceiver:
receives an input data from a user;
converts the input data to an output data;
sends the output data to the eReader, wherein the output data includes at least one eReader command.

16. The apparatus of claim 15, further comprising:
a remote control, wherein the remote control:
receives the input data from the user; and
sends the input data to the transceiver.

17. The apparatus of claim 16, wherein the remote control includes a universal remote control.

18. The apparatus of claim 16, wherein the input data includes a command from the remote control device.

19. The apparatus of claim 15, wherein the converting the input data to the output data includes converting the output data to a command in a programming language of the eReader.

20. The apparatus of claim 15, wherein the at least one eReader command includes a next page command type.

21. The apparatus of claim 15, wherein the at least one eReader command includes a previous page command type.

22. The apparatus of claim 15, wherein the at least one eReader command includes a menu command type.

23. The apparatus of claim 15, wherein the at least one eReader command includes a home command type.

24. The apparatus of claim 15, wherein the at least one eReader command includes a back command type.

25. The apparatus of claim 15, wherein the at least one eReader command includes a QWERTY command type.

26. The apparatus of claim 15, wherein the at least one eReader command includes a directional command type.

27. The apparatus of claim 26, wherein the directional command type includes at least an up command type.

28. The apparatus of claim 26, wherein the directional command type includes at least a down command type.

29. The apparatus of claim 26, wherein the directional command type includes at least a left command type.

30. The apparatus of claim 26, wherein the directional command type includes at least a right command type.
